(19) United States
(12) Patent Application Publication
(10) Pub. No.: US 2023/0074624 A1
(43) Pub. Date: Mar. 9, 2023

(54) SUBJECT MOTION MEASURING APPARATUS, SUBJECT MOTION MEASURING METHOD, MEDICAL IMAGE DIAGNOSTIC APPARATUS, AND NON-TRANSITORY COMPUTER READABLE MEDIUM

(71) Applicants: CANON KABUSHIKI KAISHA, (US); CANON MEDICAL SYSTEMS CORPORATION, (US)

(72) Inventors: Kazuhiko Fukutani, Kanagawa (JP); Toru Sasaki, Kanagawa (JP); Ryuichi Nanaumi, Tokyo (JP); Hiromi Kinebuchi, Kanagawa (JP)

(21) Appl. No.: 17/896,190

(22) Filed: Aug. 26, 2022

(30) Foreign Application Priority Data
Sep. 6, 2021 (JP) 2021-144489

(51) Int. Cl. G06T 7/20; G06T 7/00

(52) U.S. Cl. CPC G06T 7/20; G06T 7/0012; G06T 2207/10088; G06T 2207/20081

(57) ABSTRACT

A subject motion measuring apparatus includes at least one memory storing a program, and at least one processor which, by executing the program, causes the subject motion measuring apparatus to measure motion of a subject and output motion information related to the motion of the subject, reduce, from the motion information, an error caused by a disturbance other than the motion of the subject by using a trained model, and output the motion information in which the error is reduced. The trained model has functions of receiving a data set including the motion information with a plurality of degrees of freedom and outputting the motion information with the plurality of degrees of freedom in which the error is reduced.

### BACKGROUND OF THE INVENTION

### Field of the Invention

The present invention relates to a technique for measuring the motion of a subject.

### Description of the Related Art

A magnetic resonance imaging (MRI) apparatus is an apparatus that applies a radio frequency (RF) magnetic field to a subject placed on a static magnetic field and generates images of the inside of the subject based on magnetic resonance (MR) signals generated from the subject under the influence of the RF magnetic field.

In recent years, the resolution of an image output from an MRI apparatus has been increasing. With the increase in the image resolution, artifacts, which have previously been relatively inconspicuous, tend to appear more clearly, and this is a new problem desired to be improved. A motion of a head inside a head coil is known as one of the causes of such artifacts, and attempts have been made to correct a gradient magnetic field of the MRI apparatus in accordance with the head motion measured by a camera (Non-Patent Document 1).

In M. Zaitsev, C. Dold, G. Sakas, J. Hennig, and O. Speck, “Magnetic resonance imaging of freely moving objects: Prospective real-time motion correction using an external optical motion tracking system”, Neuro Image 31 (2006) 1038-1050, there is disclosed a method (hereinafter, referred to as an optical tracking system) in which a moving subject to which a marker is attached is imaged by a camera from outside, and six degrees of freedom of motion of the subject are detected based on a difference between marker positions in moving image frames.

In addition, in J. Maclaren, O. Speck, J. Hennig, and M. Zaitsev, “A Kalman filtering framework for prospective motion correction”, Proc. Intl. Soc. Mag. Reson. Med. 17 (2009), there is disclosed a method for reducing noise by applying smoothing processing using a Kalman filter to subject motion information obtained by the optical tracking system.

As disclosed in M. Zaitsev, C. Dold, G. Sakas, J. Hennig, and O. Speck, “Magnetic resonance imaging of freely moving objects: Prospective real-time motion correction using an external optical motion tracking system”, Neuro Image 31 (2006) 1038-1050, when correction is performed in accordance with the motion of a head as a subject, the six degrees of freedom of motion of the head itself need to be accurately captured. However, there are cases where an error in a tracking measurement result occurs, caused by a disturbance (for example, a vibration of a camera, a movement of skin or a marker, and the like) other than the motion of the subject. This error will be referred to as a “tracking error” or “tracking noise”. When the tracking error exists, accuracy and reliability of correction processing and a control operation in a subsequent stage are lowered, which leads to deterioration in quality of a final image (generation of artifacts).

In J. Maclaren, O. Speck, J. Hennig, and M. Zaitsev, “A Kalman filtering framework for prospective motion correction”, Proc. Intl. Soc. Mag. Reson. Med. 17 (2009), smoothing processing is disclosed. By performing this smoothing processing, an abrupt change in the motion of a subject is reduced (corrected). However, in the smoothing processing, not only the noise caused by the tracking error but also the motion of the subject may be corrected.

### SUMMARY OF THE INVENTION

With the foregoing in view, it is an object of the present invention to provide a technique for measuring the motion of the subject with high accuracy.

A further object of the present invention is to provide a technique for reducing an error caused by a disturbance from subject motion information obtained by tracking as much as possible.

According to an aspect of the present disclosure, it is provided a subject motion measuring apparatus including at least one memory storing a program, and at least one processor which, by executing the program, causes the subject motion measuring apparatus to measure motion of a subject and output motion information related to the motion of the subject, reduce, from the motion information, an error caused by a disturbance other than the motion of the subject by using a trained model, and output the motion information in which the error is reduced, wherein the trained model has functions of receiving a data set including the motion information with a plurality of degrees of freedom and outputting the motion information with the plurality of degrees of freedom in which an error is reduced.

According to an aspect of the present disclosure, it is provided a medical image diagnostic apparatus including at least one memory storing a program, and at least one processor which, by executing the program, causes the medical image diagnosis apparatus to measure motion of a subject and output motion information related to the motion of the subject, reduce, from the motion information, an error caused by a disturbance other than the motion of the subject by using a trained model, output the motion information in which the error is reduced, and perform processing using the output motion information in which the error is reduced, wherein the trained model has functions of receiving a data set including the motion information with a plurality of degrees of freedom and outputting the motion information with the plurality of degrees of freedom in which the error is reduced.

According to an aspect of the present disclosure, it is provided a subject motion measuring method including measuring motion of a subject and outputting motion information related to the motion of the subject, reducing, from the subject motion information, an error caused by a disturbance other than the motion of the subject by using a trained model obtained by machine learning, and outputting the motion information in which the error is reduced, wherein the trained model has functions of receiving a data set including the motion information with a plurality of degrees of freedom and outputting the motion information with the plurality of degrees of freedom in which the error is reduced.

According to an aspect of the present disclosure, it is provided anon-transitory computer readable medium that stores a program, wherein the program causes a computer to execute a subject motion measuring method including measuring motion of a subject and outputting motion information related to the motion of the subject, reducing, from the motion information, an error caused by a disturbance other than the motion of the subject by using a trained model obtained by machine learning, and outputting the motion information in which the error is reduced, wherein the trained model has functions of receiving a data set including the motion information with a plurality of degrees of freedom and outputting the motion information with the plurality of degrees of freedom in which the error is reduced.

Further features of the present invention will become apparent from the following description of exemplary embodiments with reference to the attached drawings.

### BRIEF DESCRIPTION OF THE DRAWINGS

FIG. 1 illustrates a configuration example of a magnetic resonance imaging apparatus:

FIGS. 2A and 2B illustrate an example of processing performed by a motion calculation unit;

FIG. 3 illustrates an example of six degrees of freedom of motion of a subject;

FIG. 4 illustrates tracking errors included in the motion of a subject;

FIG. 5 illustrates a configuration example of a subject motion measuring apparatus:

FIG. 6 illustrates an example of machine learning by a learning unit;

FIG. 7 illustrates supervised learning of CNN;

FIG. 8 illustrates an example of error-containing data and training data used for learning;

FIGS. 9A and 9B illustrate an example of a method for generating error-containing data:

FIG. 10 illustrates an example of learning data for PMC:

FIGS. 11A and 11B illustrate other examples of learning data for PMC;

FIG. 12 illustrates an example of learning data for RMC; and

FIG. 13 illustrates an example of an application result of tracking error reduction processing.

### DESCRIPTION OF THE EMBODIMENTS

Hereinafter, an embodiment of a medical image diagnostic apparatus according to the present invention will be described with reference to the drawings. The medical image diagnostic apparatus may be any modality capable of imaging a subject.

Specifically, the medical image diagnostic apparatus according to the present embodiment can be applied to a single modality such as an MRI apparatus, an X-ray computed tomography (CT) apparatus, a positron emission tomography (PET) apparatus, and a single photon emission computed tomography (SPECT) apparatus.

Alternatively, the medical image diagnostic apparatus according to the present embodiment may be applied to a combined modality such as an MR/PET apparatus, a CT/PET apparatus, an MR/SPECT apparatus, and a CT/SPECT apparatus.

The following embodiment will describe an example in which, when an MRI apparatus performs imaging of a head of an examinee, motion of the head is measured by a tracking system, and imaging conditions for MRI are corrected in accordance with the motion of the head. In this example, the head of the examinee corresponds to a “subject”. The subject is not limited to the head and may be another part of the body or the entire body. Further, the subject is not limited to a human body and may be another living body such as an animal.

### Overall Configuration of Medical Image Diagnostic Apparatus

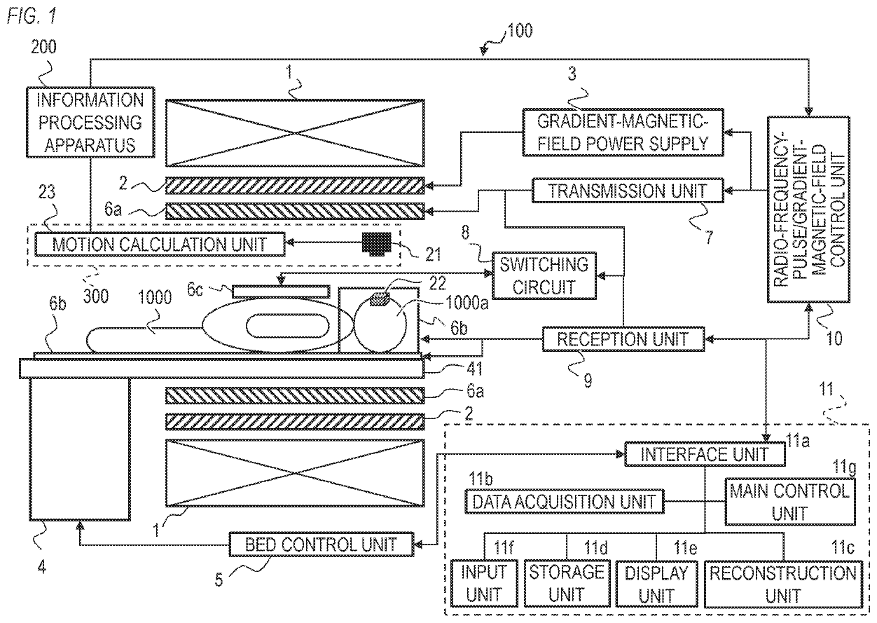

FIG. 1 illustrates a configuration of a magnetic resonance imaging apparatus 100, which is the medical image diagnostic apparatus according to the present embodiment. The magnetic resonance imaging apparatus 100 includes a static magnetic field magnet 1, a gradient magnetic field coil 2, a gradient-magnetic-field power supply 3, a bed 4, a bed control unit 5, RF coil units 6a to 6c, a transmission unit 7, a switching circuit 8, a reception unit 9, and a radio-frequency-pulse/gradient-magnetic-field control unit 10. The magnetic resonance imaging apparatus 100 further includes a computer system 11, an optical imaging unit 21, a motion calculation unit 23, and an information processing apparatus 200.

The static magnetic field magnet 1 has a hollow cylindrical shape and generates a uniform static magnetic field in an internal space thereof. For example, a superconducting magnet or the like is used as the static magnetic field magnet 1.

The gradient magnetic field coil 2 has a hollow cylindrical shape and is disposed on the inside of the static magnetic field magnet 1. The gradient magnetic field coil 2 is formed by combining three types of coils corresponding to X-, Y-, and Z-axes that are orthogonal to one another. These three types of coils are individually supplied with electric current from the gradient-magnetic-field power supply 3 and the gradient magnetic field coil 2 generates gradient magnetic fields whose magnetic field strength changes along each of the X-, Y-, and Z-axes. The Z-axis direction is assumed to be, for example, a direction parallel to the static-magnetic-field direction. The gradient magnetic fields of the X-, Y-, and Z-axes correspond to, for example, a slice-selection gradient magnetic field Gs, a phase-encoding gradient magnetic field Ge, and a readout gradient magnetic field Gr, respectively. The slice-selection gradient magnetic field Gs is used for arbitrarily determining a cross-sectional plane to be imaged. The phase-encoding gradient magnetic field Ge is used for changing the phase of a magnetic resonance signal in accordance with a spatial position. The readout gradient magnetic field Gr is used for changing the frequency of a magnetic resonance signal in accordance with a spatial position.

An examinee 1000 is inserted into space (imaging space) inside the gradient magnetic field coil 2 while lying on his or her back on a top board 41 of the bed 4. This imaging space will be referred to as the inside of a bore. The bed control unit 5 controls the bed 4 so that the top board 41 moves in longitudinal directions (the left-and-right directions in FIG. 1) and in up-and-down directions. The bed 4 is normally installed such that the longitudinal direction thereof is parallel to the central axis of the static magnetic field magnet 1.

The RF coil unit 6a is for transmission. The RF coil unit 6a is configured by accommodating one or more coils in a cylindrical case. The RF coil unit 6a is arranged on the inside of the gradient magnetic field coil 2. The RF coil unit 6a is supplied with radio-frequency signals (RF signals) from the transmission unit 7 and generates a radio-frequency magnetic field (RF magnetic field). The RF coil unit 6a can generate the RF magnetic field in a wide region so as to include a large portion of the examinee 1000. That is, the RF coil unit 6a includes a so-called whole-body (WB) coil.

The RF coil unit 6b is for reception. The RF coil unit 6b is mounted on the top board 41, built in the top board 41, or attached to a subject 1000a of the examinee 1000. At the time of imaging, the RF coil unit 6b is inserted into the imaging space together with the subject 1000a. Any type of RF coil unit can be mounted as the RF coil unit 6b. The RF coil unit 6b detects a magnetic resonance signal generated by the subject 1000a. In particular, an RF coil for the head will be referred to as ahead RF coil.

The RF coil unit 6c is for transmission and reception. The RF coil unit 6c is mounted on the top board 41, built in the top board 41, or attached to the examinee 1000. At the time of imaging, the RF coil unit 6c is inserted into the imaging space together with the examinee 1000. Any type of RF coil unit can be mounted as the RF coil unit 6c. The RF coil unit 6c is supplied with RF signals from the transmission unit 7 and generates an RF magnetic field. Further, the RF coil unit 6c detects a magnetic resonance signal generated by the examinee 1000. An array coil formed by arranging a plurality of coil elements can be used as the RF coil unit 6c. The RF coil unit 6c is smaller than the RF coil unit 6a and generates an RF magnetic field that includes only a local portion of the examinee 1000. That is, the RF coil unit 6c includes a local coil. A local transmission/reception coil may be used as a head coil.

The transmission unit 7 selectively supplies an RF pulse corresponding to a Larmor frequency to the RF coil unit 6a or the RF coil unit 6c. The transmission unit 7 supplies the RF pulse to the RF coil unit 6a or to the RF coil unit 6c with a different amplitude and phase based on, for example, a difference in the magnitude of the corresponding RF magnetic field to be formed.

The switching circuit 8 connects the RF coil unit 6c to the transmission unit 7 during a transmission period in which the RF magnetic field is to be generated and to the reception unit 9 during a reception period in which a magnetic resonance signal is to be detected. The transmission period and the reception period are instructed by the computer system 11. The reception unit 9 performs processing such as amplification, phase detection, and analog-to-digital conversion on the magnetic resonance signal detected by the RF coil unit 6b or 6c and obtains magnetic resonance data.

The computer system 11 includes an interface unit 11a, a data acquisition unit 11b, a reconstruction unit 11c, a storage unit 11d, a display unit 11e, an input unit 11f, and a main control unit 11g. The radio-frequency-pulse/gradient-magnetic-field control unit 10, the bed control unit 5, the transmission unit 7, the switching circuit 8, the reception unit 9, and the like are connected to the interface unit 11a. The interface unit 11a inputs and outputs signals exchanged between each of these connected units and the computer system 11. The data acquisition unit 11b acquires magnetic resonance data output from the reception unit 9. The data acquisition unit 11b stores the acquired magnetic resonance data in the storage unit 11d. The reconstruction unit 11c performs post processing, that is, reconstruction such as Fourier transformation, on the magnetic resonance data stored in the storage unit 11d so as to obtain spectrum data or MR image data about desired nuclear spin in the examinee 1000. The storage unit 11d stores the magnetic resonance data and the spectrum data or the image data for each examinee. The display unit 11e displays various kinds of information such as the spectrum data or the image data under the control of the main control unit 11g. As the display unit 11e, a display device such as a liquid crystal display can be used as appropriate. The input unit 11f receives various kinds of instructions and information input from an operator. As the input unit 11f, a pointing device such as a mouse and a track ball, a selection device such as a mode selection switch, or an input device such as a keyboard can be used. The main control unit 11g includes a CPU (processor), a memory, and the like (not illustrated) and comprehensively controls the magnetic resonance imaging apparatus 100.

Under the control of the main control unit 11g, the radio-frequency-pulse/gradient-magnetic-field control unit 10 controls the gradient-magnetic-field power supply 3 and the transmission unit 7 so as to change each gradient magnetic field in accordance with a pulse sequence needed and to transmit the RF pulse. Further, the radio-frequency-pulse/gradient-magnetic-field control unit 10 can also change each gradient magnetic field based on information related to the motion of the subject 1000a transmitted from the motion calculation unit 23 via the information processing apparatus 200. The functions of the radio-frequency-pulse/gradient-magnetic-field control unit 10 may be integrated into the functions of the main control unit 11g.

The optical imaging unit 21, a marker 22, the motion calculation unit 23, and the information processing apparatus 200 detect motion of the subject 1000a and transmit the detected motion to the radio-frequency-pulse/gradient-magnetic-field control unit 10. Based on the transmitted motion, the radio-frequency-pulse/gradient-magnetic-field control unit 10 controls the gradient magnetic field so as to make the imaging plane approximately constant. This makes it possible to obtain image data in which motion artifacts do not occur even when the subject moves. In other words, an image in which the motion is corrected can be obtained. A motion correction method in which the gradient magnetic field is changed in real time in accordance with measured motion of a subject to constantly maintain the imaging plane is commonly called a prospective motion correction. There is also another method called a retrospective motion correction. In this method, the motion of a subject is measured and recorded during MR imaging, and after the MR imaging, motion correction is performed on the MR images by using motion measurement data. Either of these motion correction methods may be used as long as motion artifacts can be reduced compared to conventional MR images.

Note that, in a case of a rigid body in three-dimensional space, “motion” generally indicates motion with six degrees of freedom, which is expressed with three degrees of freedom in rotation and three degrees of freedom in translation. The present specification will be described using an example in which motion with six degrees of freedom is obtained. However, any degrees of freedom may be used to express the motion of the subject.

The optical imaging unit 21 is commonly a camera. However, any sensing device that can optically image or capture a subject may be used. In the present embodiment, to assist accurate capturing of the motion and position of the subject, a marker on which a predetermined pattern is printed is attached to the subject, and the marker is imaged by the optical imaging unit 21. Alternatively, the motion of the subject may be captured by tracking feature points of the subject itself, for example, wrinkles as a skin texture, a pattern of eyebrows, a nose which is a characteristic facial organ, a periphery of eyes, a shape of a forehead, or the like, without using the marker.

In a configuration in which a camera is used as the optical imaging unit 21, the number of cameras may be one, or two or more. For example, if a marker is used and the positional relationship between a plurality of feature points on a pattern in the marker is known, the motion of the marker can be calculated from images obtained by a single camera. If a marker is not used, or if the positional relationship between feature points is not known even when a marker is used, three-dimensional information about the subject may be measured by so-called stereo imaging. There are various stereo imaging methods such as passive stereo imaging using at least two cameras and active stereo imaging combining a projector and a camera, and any method may be used. By increasing the number of cameras to be used, various movements of axes can be measured more accurately.

In addition, it is desirable that the optical imaging unit 21 be compatible with MR. Being compatible with MR means having a configuration in which noise affecting image data at the time of MR imaging is reduced as much as possible and being able to operate normally even in a strong magnetic field environment. For example, a radio-frequency (RF)-shielded camera using no magnetic material is an example of the MR-compatible camera. Further, the optical imaging unit 21 can be disposed inside a bore which is a space surrounded by the static magnetic field magnet 1 and the gradient magnetic field coil 2 as illustrated in FIG. 1. In a case where there is no space in the bore, the optical imaging unit 21 can be disposed outside the bore. As long as the optical imaging unit 21 can image the marker or subject within a predetermined imaging range (field of view: FOV), the optical imaging unit 21 may be disposed in any arrangement.

When a camera is used as the optical imaging unit 21, illumination (not illustrated) may be used. By using illumination, the marker or the subject can be imaged with high contrast. It is desirable that the illumination be also compatible with MR, and MR-compatible LED illumination or the like can be used. The illumination of any wavelength and wavelength band, such as white light, monochromatic light, near-infrared light, or infrared light, may be used, as long as the marker or the subject can be imaged with high contrast. However, in consideration of the burden on the subject, near-infrared light or infrared light, which has invisible wavelength, is preferable.

The motion calculation unit 23 will be described. The motion calculation unit 23 analyzes an image captured by the optical imaging unit 21 and calculates motion of the feature points of the marker 22 or motion of the feature points of the subject 1000a. The motion calculation unit 23 may be configured by a computer having a processor, such as a CPU, a GPU, or an MPU, and a memory, such as a ROM or a RAM, as hardware resources and a program executed by the processor. Alternatively, the motion calculation unit 23 may be realized by an application-specific integrated circuit (ASIC), a field programmable gate array (FPGA), another complex programmable logic device (CPLD), or a simple programmable logic device (SPLD).

The optical imaging unit 21 and the motion calculation unit 23 are collectively referred to as a tracking system 300. This tracking system 300 is an example of a measuring unit that measures the motion of the subject and outputs subject motion information. While the optical tracking system using a camera has been described here, any tracking system capable of measuring the motion of the subject in a non-contact manner may be used. For example, a method using a magnetic sensor or a small receiving coil (tracking coil) may be used.

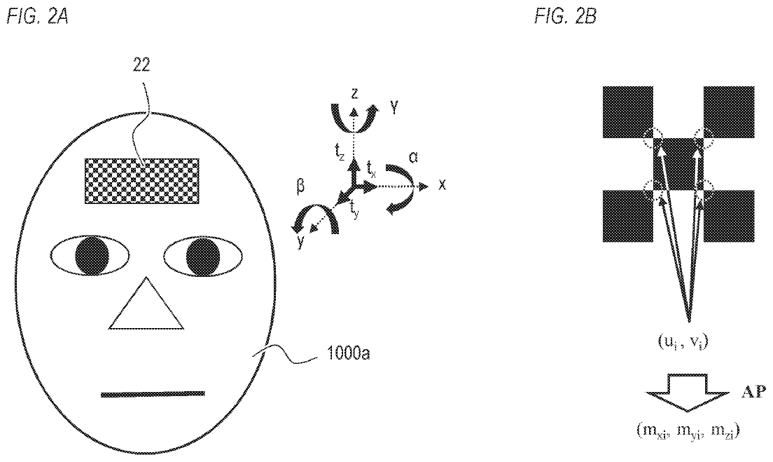

An example of processing performed by the motion calculation unit 23 will be described with reference to FIGS. 2A and 2B. Here, as illustrated in FIG. 2A, a case where the marker 22 for motion measurement is fixed to the head of the subject 1000a will be described. The motion calculation unit 23 acquires a moving image obtained by imaging the marker from the optical imaging unit 21 and calculates the motion of the marker from each frame image of the moving image. It is assumed that the internal parameter matrix A (3×3 matrix) of the camera has been acquired in advance by calibration.

A specific example of a motion calculation method will be described. In this example, one camera and a marker using a checkerboard pattern is used. As illustrated in FIG. 2B, a pixel position (uᵢ, vᵢ) of feature points is calculated from the pattern on the marker in a camera image at each time. Note that a subscript “i” indicates that there are a plurality of feature points. In the following description, the subscript “i” may be omitted. In the case of a checkerboard pattern, for example, each corner thereof is set as a feature point. Further, assuming that the relative positional relationship of each of the feature points in the pattern on the marker is known and a marker coordinate system is used as the coordinate system in this case, three-dimensional coordinates of each feature point are (mₓᵢ, m_{yi}, m_{zi}). The pixel position (uᵢ, vᵢ) in a camera coordinate system and the coordinates (mₓᵢ, m_{yi}, m_{zi}) of the corresponding feature point in the marker coordinate system can be expressed by the following relational expression.

$$[ \begin{matrix}u \\ v \\ 1\end{matrix} ] = AP [ \begin{matrix}{m}_{x} \\ {m}_{y} \\ {m}_{z} \\ 1\end{matrix} ]$$

Here, A is an internal matrix (3×3 matrix) of the camera, and P (3×4 matrix) is a projection matrix that includes a rotation matrix and a translation matrix. P is expressed as follows.

$$P = [ \begin{matrix}{R}_{11} & {R}_{12} & {R}_{13} & {t}_{x} \\ {R}_{21} & {R}_{22} & {R}_{23} & {t}_{y} \\ {R}_{31} & {R}_{32} & {R}_{33} & {t}_{z}\end{matrix} ] = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] + [ \begin{matrix}{t}_{x} \\ {t}_{y} \\ {t}_{z}\end{matrix} ] = R + t$$

$$R = [ \begin{matrix}{R}_{11} & {R}_{12} & {R}_{13} \\ {R}_{21} & {R}_{22} & {R}_{23} \\ {R}_{31} & {R}_{32} & {R}_{33}\end{matrix} ] = \\ [ \begin{matrix}cos β cos γ & - cos β sin γ & sin β \\ sin α sin β cos γ + cos α sin γ & - sin α sin β sin γ + cos α cos γ & - sin α cos β \\ - cos α sin β cos γ + sin α sin γ & cos α sin β sin γ + sin α cos γ & cos α cos γ\end{matrix} ]$$

$$t = [ \begin{matrix}{t}_{x} \\ {t}_{y} \\ {t}_{z}\end{matrix} ]$$

Here, as illustrated in FIG. 2A, α, β, and γ are rotation angles around x-, y-, and z-axes, respectively, representing three degrees of freedom in rotation, and tₓ, t_{y}, and t_{z} are moving amounts in x, y, and z directions, respectively, representing three degrees of freedom in translation. In a case of a rigid body, its motion can be expressed with these six degrees of freedom.

The projection matrix P represents a transformation matrix from the marker coordinate system (or the world coordinate system) to the camera coordinate system with respect to the corresponding feature point. The projection matrix P has twelve variables (six degrees of freedom). For example, the projection matrix P can be obtained by using a six-point algorithm that uses the relationship between at least six points of pixel positions (uᵢ, vᵢ) in the camera coordinate system and corresponding coordinates (mₓᵢ, m_{yi}, m_{zi}) of the feature points in the marker coordinate system. Note that as long as the projection matrix P is obtained, any other method, such as a non-linear solution, may be used.

Assuming that a projection matrix obtained from a camera image acquired at a time t₀ is Pₜ₀, and a projection matrix obtained from a camera image acquired at a time t₁ of the next frame is Pₜ₁, the motion (P_{camera,t0→t1}) of the marker from the time t₀ to the time t₁ can be obtained by the following equation.

P_{camera,t0→t1}=Pₜ₁P⁻¹ₜ₀

As a result, the six degrees of freedom (α, β, γ, tₓ, t_{y}, t_{z}) of motion as illustrated in FIG. 2A can be calculated.

While one example of the calculation method has been described here, any other method may be used as long as the six degrees of freedom of motion at each time can be calculated. For example, while the motion is obtained from the images captured by one camera has been described in this example, the motion may be obtained by using images captured by two or more cameras. By complementarily using images captured by a plurality of cameras, it is possible to accurately capture the six degrees of freedom of motion. Further, in a case where the relative positions between the feature points on the marker are unknown, three-dimensional coordinates of each feature point may be obtained by using three-dimensional measurement means that performs stereo imaging. In such a case, three-dimensional coordinates (mₓᵢ, m_{yi}, m_{zi}) of each feature point correspond to the three-dimensional coordinates obtained by the three-dimensional measurement means that performs stereo imaging. If the three-dimensional measurement means that performs stereo imaging is used, relative position information between feature points does not need to be known. Therefore, for example, skin textures such as wrinkles can be used as feature points to capture six degrees of freedom of motion of the subject 1000a. In this case, there is no need to attach the marker to the subject 1000a. Thus, the burden on the examinee can be reduced.

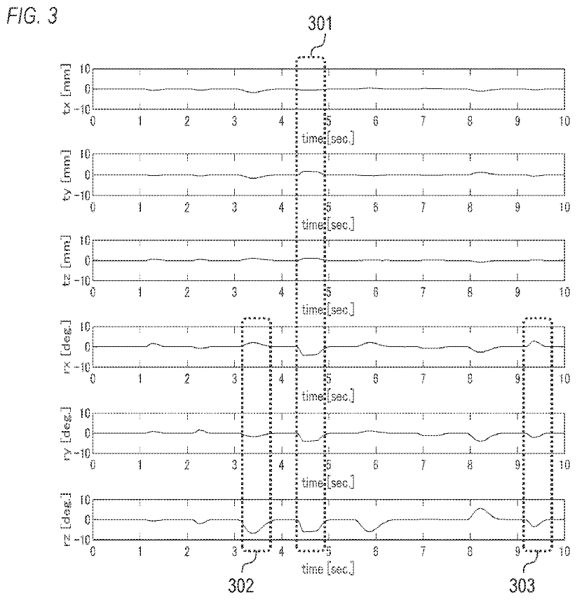

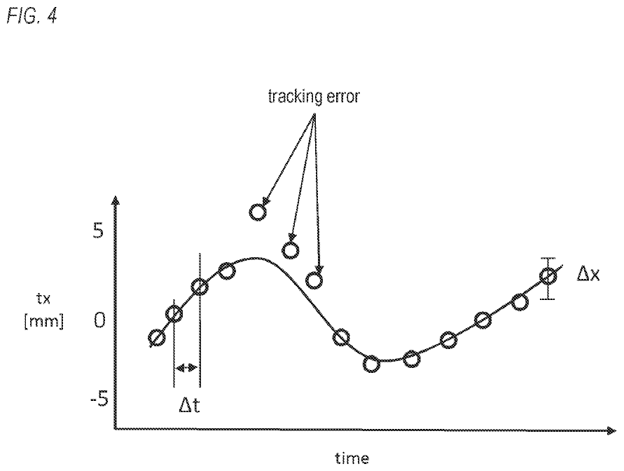

The motion of the subject 1000a can be generally obtained by the methods described above. However, there are cases where the relative positional relationship between the feature points is changed during measurement for some reason, or the measurement value is affected by a disturbance other than the motion of the subject, for example, by a vibration of a camera, a movement of skin to which the marker is attached, and the like. Such an error in the measurement value caused by a disturbance factor other than the motion of the subject will be referred to as a “tracking error”. The tracking error will be described with reference to FIGS. 3 and 4.

In a case where the subject is a rigid body, measurement results for variables (tx, ty, tz, rx, ry, rz) of six degrees of freedom illustrated in FIG. 3 are obtained from the tracking system 300 at each time. In FIG. 3, α, β, and γ in FIG. 2A are represented by rx, ry, and rz, respectively. Normally, each of the six degrees of freedom of motion is an independently movable motion. However, for example, the head during MR imaging cannot move freely since the examinee is lying on a bed and the head is fixed to some extent by a fixture in the head coil. When there is such a constraint, for example, it is difficult to make a simple movement such as moving the head only in the x direction or rotating the head only around the z-axis. This creates motion in which a plurality of degrees of freedom in translation and rotation are mixed. In addition, due to the constraint, there are often trends or patterns in how the movements are mixed. Such characteristics or correlation observed in the six degrees of freedom of motion of the subject will be referred to as “linkage”. In the measurement results in FIG. 3, too, for example, the six degree of freedom (tx, ty, tz, rx, ry, rz) exhibit similar fluctuations (although there are a difference between positive and negative and a difference in amplitude) in a period indicated by reference numeral 301. In addition, in periods indicated by reference numerals 302 and 303, motion with a similar tendency, which contains rotation in the positive direction around the x-axis and rotation in the negative direction around the y- and z-axes, appears.

FIG. 4 is a schematic diagram illustrating measurement results (represented by circles) of the motion of a subject making a known motion (solid line). FIG. 4 illustrates only the variable tx among the variables of six degrees of freedom illustrated in FIG. 3. Since the measurement cannot usually be performed continuously, the measurement is performed at certain time intervals (in this case, every Δt). In addition, the measurement value matches the actual motion within measurement accuracy (Δx). This measurement accuracy refers to a certain range of variation that the measurement value usually exhibits due to a camera calibration error and an image processing error. However, in the actual measurement, an unnecessary error (tracking error) exceeding the measurement accuracy is added due to the impact of a vibration of the camera, which is the optical imaging unit 21, a movement of skin of the subject, and the like. The tracking error is usually larger than the measurement accuracy. Therefore, the motion correction using data containing such a tracking error, which exceeds the measurement accuracy, cannot reduce artifacts and causes image deterioration. In the present embodiment, processing for reducing the tracking error is performed.

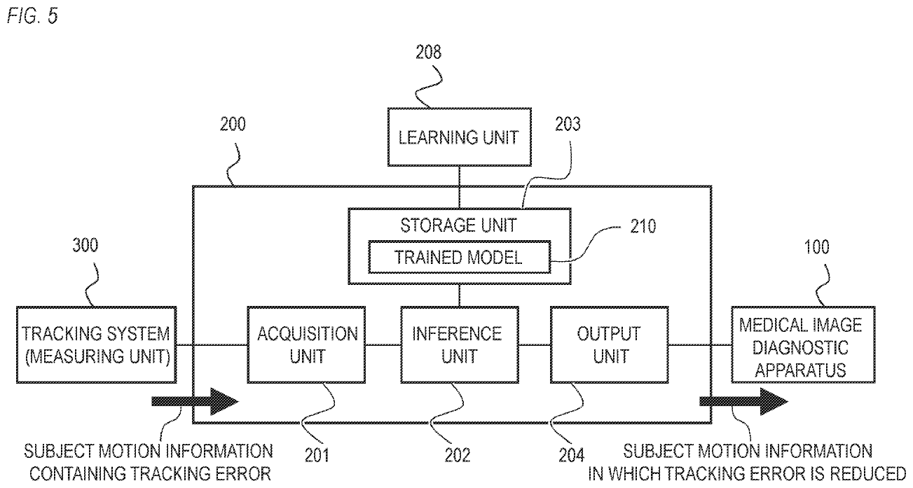

FIG. 5 is a block diagram illustrating a configuration of a subject motion measuring apparatus according to the present embodiment. The subject motion measuring apparatus includes the tracking system (measuring unit) 30) and the information processing apparatus 200. The tracking system 300 measures the motion of a subject and outputs subject motion information (for example, motion information with six degrees of freedom). Based on “subject motion information containing a tracking error” output from the tracking system 300, the information processing apparatus 200 infers “subject motion information in which the tracking error is reduced” and outputs motion information in which an error has been reduced to the medical image diagnostic apparatus 100.

A functional configuration of the information processing apparatus 200 will be described with reference to FIG. 5. The information processing apparatus 200 includes an acquisition unit 201, an inference unit 202, a storage unit 203, and an output unit 204 as main functions. The information processing apparatus 200 may have a learning unit 208 as needed (if the information processing apparatus 200 only needs to perform inference using a trained model generated in advance, the information processing apparatus 200 does not need to include the learning unit 208).

The information processing apparatus 200 may be configured by, for example, a computer including a processor such as a CPU, a GPU, or an MPU and a memory such as a ROM or RAM as hardware resources, and a program executed by the processor. In the case of this configuration, functional blocks 201, 202, 203, 204, and 208 illustrated in FIG. 5 are realized by the processor executing the program. Alternatively, all or some of the functions illustrated in FIG. 5 may be implemented by an application-specific integrated circuit (ASIC), a field programmable gate array (FPGA), another complex programmable logic device (CPLD), or a simple programmable logic device (SPLD). The hardware resources can be shared with the motion calculation unit 23.

Each configuration of the information processing apparatus 200 may be configured as an independent apparatus or may be configured as one function of the tracking system 300 or one function of the medical image diagnostic apparatus 100. The present configuration or a part of the present configuration may be realized on a cloud via a network.

The acquisition unit 201 in the information processing apparatus 200 acquires subject motion information to be processed from the tracking system (measuring unit) 300. The subject motion information is provided as time-series data representing measurement values of each of the six degrees of freedom (for example, a data string of each of the measurement values tx, ty, tz, rx, ry, and rz for a period of one second). The subject motion information output from the tracking system 300 may contain the tracking error described above. When acquiring the subject motion information containing the error, the acquisition unit 201 transmits data to be processed to the inference unit 202.

The inference unit 202 in the information processing apparatus 200 performs error reduction processing for reducing, from the subject motion information acquired by the acquisition unit 201, an error (tracking error) caused by a disturbance other than the motion of the subject by using a trained model 210. It is desirable that the trained model 210 stored in the storage unit 203 is a trained model on which machine learning is performed by the learning unit 208 before being included in the inference unit 202. However, the learning unit 208 may be built in the information processing apparatus 200 to perform online learning using actual measurement results of a patient. The trained model 210 may be stored in the storage unit 203 in advance or may be provided via a network. The output unit 204 outputs, to the medical image diagnostic apparatus 100, inference results obtained by the inference unit 202, that is, subject motion information in which the tracking error has been reduced. The subject motion information in which the tracking error has been reduced is used for, for example, a control operation for reducing motion artifacts and image processing, in the medical image diagnostic apparatus 100.

### Machine Learning

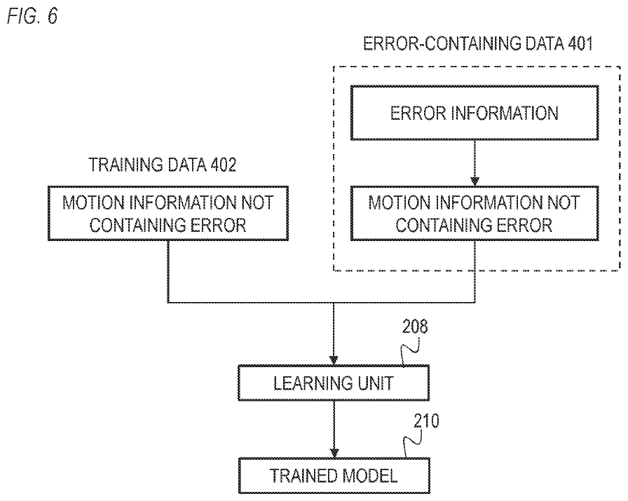

The machine learning will be described with reference to FIG. 6. The learning unit 208 receives training data (correct answer data) 402, which is motion information not containing a tracking error, and error-containing data 401, which is motion information containing a tracking error. The motion information is provided as time-series data (data string) representing values of each of the six degrees of freedom (tx, ty, tz, rx, ry, rz) as illustrated in FIG. 3. The error-containing data 401 is generated by adding a tracking error component (referred to as “error information”) generated by simulating a disturbance (a vibration of a camera or an apparatus, a movement of skin, or the like) to motion information not containing a tracking error.

The learning unit 208 generates learning data by matching (associating) the error-containing data 401 and corresponding training data (correct answer data not containing an error) 402 as a set. The learning unit 208 stores the learning data in the memory. Next, the learning unit 208 performs supervised learning using the learning data stored in the memory and learns a relationship between the motion information containing the tracking error and the motion information not containing the tracking error. The learning unit 208 performs the learning using a large number of learning data and obtains a trained model 210, which is a result of the learning. The trained model 210 is used for the tracking error reduction processing performed by the inference unit 202 in the information processing apparatus 200.

The training data 402 used for learning is motion information not containing a tracking error. The motion of the subject is actually measured by the tracking system under an environment or condition in which a tracking error does not occur so as to obtain motion information that contains almost no tracking error, and the obtained motion information may be used as the training data 402. For example, by installing the camera of the tracking system to be isolated from a vibration source or installing vibration-isolating means, it is possible to eliminate a tracking error caused by the vibration of the camera. In addition, by performing the measurement by moving only the head while forcibly fixing the expression of the face, it is possible to obtain a tracking measurement result containing almost no tracking error caused by the movement of the skin or the like. The method for obtaining the training data 402 with actual measurement is not limited to these methods, and other methods may be used. The training data 402 is preferably created from actual measurement data obtained from a large number of subjects. In addition, the training data 402 may be data generated by computer simulation, instead of actual measurement data. Further, the training data may be augmented by data augmentation based on actual measurement data and simulation data.

The error-containing data 401 is data in which error information that is artificially generated is added to motion information not containing a tracking error. The error information refers to a tracking error mixed into a motion obtained by using a camera image when a disturbance, such as a vibration of the camera or a movement of skin, is mixed into the camera image. When the error information is added, it is preferable that an error component be added to the camera image itself or to coordinate data representing feature points calculated from the camera image. This is because, by modifying the camera image or coordinate data representing the feature points and calculating motion information with six degrees of freedom from the modified data, the tracking error can be superimposed while maintaining the linkage in the six degrees of freedom of motion. However, for the sake of simplicity, the tracking error may be added by using a method in which the values of the motion information with six degrees of freedom are directly modified.

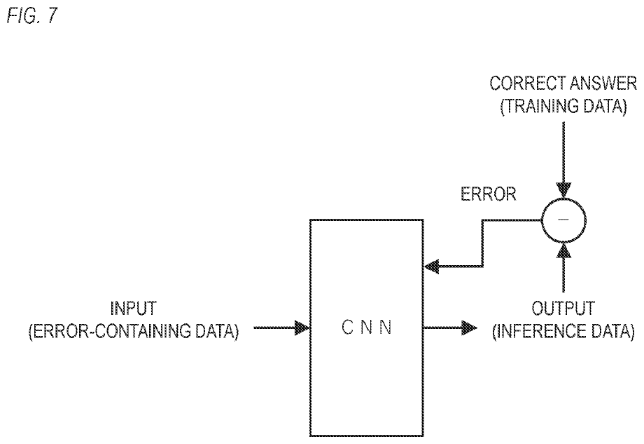

As a specific algorithm for the learning, deep learning in which a feature amount and a connection weighting coefficient for learning are generated by itself by using a neural network. For example, the deep learning is realized by a convolution neural network (CNN) having convolutional layers. FIG. 7 schematically illustrates supervised learning of the CNN. In the supervised learning of the CNN, for example, the CNN receives the error-containing data 401 as an input and performs calculation, and a connection weighting coefficient or the like of each layer is corrected by back-propagating an error between an output (inference data) of the CNN and the training data 402. By repeating this operation, a trained model having a function (ability) of outputting, when receiving motion information containing a tracking error as an input, motion information in which the tracking error is reduced can be obtained.

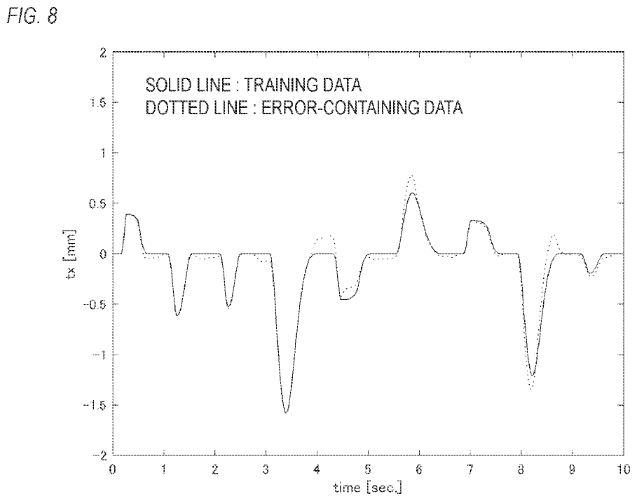

FIG. 8 is a schematic diagram illustrating an example of the error-containing data 401 and the training data 402 used for learning. An example of a method for generating the training data 402 provided at the time of learning will be described. In this example, the motion of a head during MR imaging is obtained using simulation, assuming a case where six degrees of freedom of motion of the head during MR imaging are measured by the optical tracking using a marker and camera images.

As described above, the motion of the head is restricted during MR imaging, and the six degrees of freedom of motion have linkage. In this simulation, the following conditions are set in consideration of such characteristics. The center point of a rotational movement of the head is selected at random within a range of ±20 [mm] from a reference point every time the head is moved, the reference point being set at a position 90 [mm] from the center portion between the eyebrows toward the back of the head. The motion of the head is assumed to be a short pulse-like movement or a long movement. In the case of MRI, since a person is lying on a bed and the movement of the base portion of the neck is restricted, it is assumed that a large movement in the horizontal direction is difficult to make. Thus, the motion of the head is assumed to be mainly a rotational movement. Since a relaxed state is assumed to be an initial state, it takes more time to return to the original position than when a motion is initiated. Human muscles move faster when the muscles contract with force than when the muscles return to their original state releasing the force.

An example of such motion of the head is indicated by a solid line in FIG. 8. FIG. 8 illustrates only an example of translation (tx) in the x direction. In practice, however, all the six degrees of freedom of motion (tx, ty, tz, rx, ry, rz) are calculated as illustrated in FIG. 3. In this example, the tracking speed is set to 50 Hz, and the motion is calculated every 1/50 second. Specifically, the rotational and translational movements of the head are simulated by the simulation using a 3D model of the head, and values of the three-dimensional coordinates (mₓᵢ, m_{yi}, m_{zi}) of the pattern of the marker fixed to the head are calculated every 1/50 second. Next, pixel positions (uᵢ, vᵢ) in the camera coordinate system corresponding to the three-dimensional coordinates (mₓᵢ, m_{yi}, m_{zi}) are calculated and converted into data representing six degrees of freedom of motion (tx, ty, tz, rx, ry, rz) of the head by using the same algorithm as the motion calculation algorithm used by the motion calculation unit 23. The obtained motion data serves as the training data 402. This motion data coincides with the rotational and translational movements given to the model within the calculation error range. In the simulation, data representing various movements of the head may be generated as the training data 402 by changing parameters of the movement given to the head.

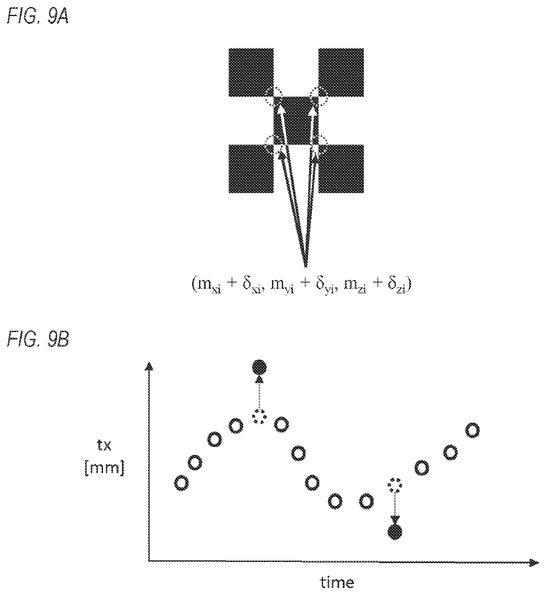

Next, the error-containing data 401 used for learning will be described. The error-containing data 401 is obtained by adding error information to the motion information used as training data 402. Here, an example of the error information in which the marker includes a vibration of the camera will be generated using a simulation. First, as in the case of the training data 402, values of the three-dimensional coordinates (mₓᵢ, m_{yi}, m_{zi}) of the pattern of the marker fixed to the head are calculated every 1/50 second in the simulation using a 3D model of the head. Next, as illustrated in FIG. 9A, for example, the three-dimensional coordinates (mₓᵢ, m_{yi}, m_{zi}) of the pattern of the marker are shifted from the normal position by the amount of the vibration (δₓᵢ, δ_{yi}, δ_{zi}) of the camera. Next, pixel positions (uᵢ, vᵢ) in the camera coordinate system corresponding to the three-dimensional coordinates (mₓᵢ+δₓᵢ, m_{yi}+δ_{yi}, m_{zi}+δ_{zi}) of the marker to which the error has been added are calculated, and data representing six degrees of freedom of motion (tx, ty, tz, rx, ry, rz) of the head is calculated by using the same algorithm as the motion calculation algorithm of the motion calculation unit 23. The obtained motion data serves as the data representing the motion of the head containing the tracking error.

A dotted line in FIG. 8 indicates an example of translational movement (tx) in the x direction containing the tracking error. When comparing a solid line and the dotted line in FIG. 8, it can be seen that there is a slight difference. In the simulation, various data may be generated by changing error parameters of the three-dimensional coordinates based on the model of the vibration of the camera. The obtained data serves as the error-containing data. For example, since the apparatus vibrates differently depending on the imaging mode of MRI, a plurality of camera-vibration models corresponding to respective imaging modes may be prepared, and error-containing data corresponding to the vibration that can occur in each imagine mode may be generated. Further, the error-containing data may be generated by assuming variations in a change of facial expression or in skin movement and adding error components (δₓᵢ, δ_{yi}, δ_{zi}) corresponding thereto.

In the present embodiment, first, three-dimensional coordinates of feature points (for example, the pattern of the marker) are calculated based on the rotational and translational movements of the head during MR imaging. Next, data representing six degrees of freedom of motion is calculated from the three-dimensional coordinate data representing the feature points and corresponding camera pixel coordinates by using the same algorithm as the motion calculation algorithm, thereby generating the training data 402. By adopting such a procedure, it is possible to generate the training data 402 that simulates actual six degrees of freedom of motion of the subject during MR imaging and the linkage thereof. In addition, after an error is added to the three-dimensional coordinates of the feature points, data representing six degrees of freedom of motion is calculated in a similar manner by using the same algorithm as the motion calculation algorithm, thereby generating the error-containing data. As described above, by adopting the procedure in which the error component is added to the coordinate data representing the feature points, it is possible to superimpose the tracking error while maintaining the linkage in the six degrees of freedom of motion. Thus, learning data with high validity can be prepared.

The present embodiment adopts the method for generating motion information containing a tracking error, that is, error-containing data by adding an error to the three-dimensional coordinates of the feature points as described above. However, the error-containing data may be generated by any method as long as the motion information containing the tracking error is generated. For example, as in FIG. 9B, a tracking error may be directly added to the data representing six degrees of freedom of motion (tx, ty, tz, rx, ry, rz) without considering models of the feature points or the like. In the example in FIG. 9B, outliers (black circles) are added to the motion data tx (white circles) not containing a tracking error, which is obtained by actual measurement or simulation. As described above, the data to which the tracking error is added serves as the error-containing data.

In the example of the present embodiment, 2000 patterns of training data are generated for a 10-second motion of the head, and error-containing data is generated from each of the training data. These sets of the error-containing data and the training data are used for learning.

Next, a learning method using the error-containing data and the training data will be described. As described above, examples of the method for correcting the motion of the subject in the MRI apparatus include prospective motion correction (PMC) and retrospective motion correction (RMC). Since the input data that can be used for the inference processing by the inference unit 202 is different between a case where the tracking error reduction processing according to the present embodiment is applied to the PMC method and a case where the same processing is applied to the RMC method, the learning data needs to be designed accordingly.

In the PMC method, a gradient magnetic field is changed in real time in accordance with the motion of the subject measured by the tracking system. Therefore, the inference unit 202 needs to sequentially perform the tracking error reduction processing on the subject motion information output from the tracking system and output motion information in which the error has been reduced to the radio-frequency-pulse/gradient-magnetic-field control unit 10. In this case, since the inference unit 202 applies the inference processing to the latest measurement data, there is a constraint that, while past data can be used for the inference processing, future data cannot be used for the inference processing.

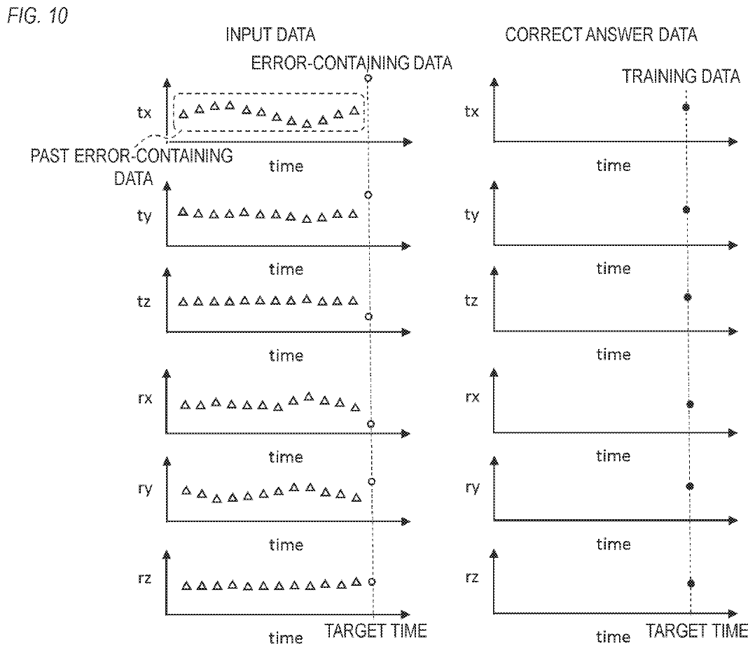

FIG. 10 illustrates an example of learning data for PMC. The input data is a set of error-containing data with six degrees of freedom (tx, ty, tz, rx, ry, rz). The error-containing data in each degree of freedom is time-series data including error-containing data (white circle) at a target time and error-containing data (white triangles) in the past before the target time. The target time refers to a measurement time of data subjected to the error reduction processing (inference processing). In this example, data representing past 50 points (that is, time-series data for a period of one second) is used. The correct answer data is training data (black circles) in six degrees of freedom at a target time. By repeating calculation and learning at each measurement time using such learning data, it is possible to generate a trained model for estimating the motion of the subject in which a tracking error is reduced in real time, from the time-series data representing the subject motion information obtained for a predetermined period of time. When such a trained model is used, it is possible to perform inference in consideration of temporal linkage of the motions of the subject, linkage between a plurality of degrees of freedom, and the like. Thus, the tracking error can be reduced with high accuracy.

The learning data illustrated in FIG. 10 is merely an example. For example, instead of learning all six degrees of freedom of motion simultaneously, a combination of at least two degrees of freedom selected from the six degrees of freedom may be formed and learned individually. In this case, a trained model is generated for each combination of degrees of freedom (for example, in a case where three combinations of tx and rx, ty and ry, and tz and rz are formed, three trained models are generated). If a combination of degrees of freedom that exhibits strong linkage is known in advance, the learning may be performed using this combination. FIG. 1I A illustrates an example in which the learning is performed on a combination of two degrees of freedom (tx and rx) as a set.

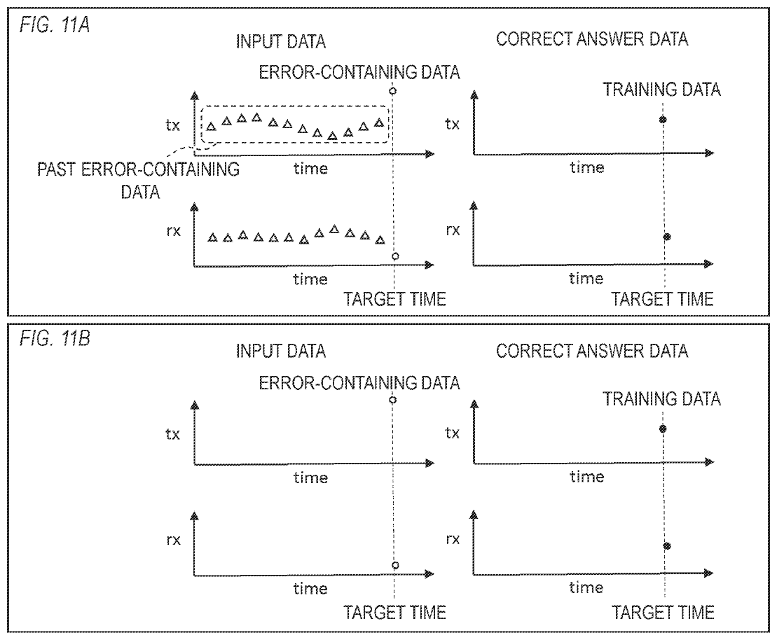

In addition, in the example in FIG. 10, data representing past 50 points (for a period of one second) is given as input data. However, any number of points of past data may be given. Past data for more than one second may be given, or past data for less than one second or past data representing only one point immediately before may be given. Alternatively, as illustrated in FIG. 11B, only error-containing data at a target time may be given as the input data without using the past data.

While past error-containing data is given as the past data in the example in FIG. 10, past inference data may be given instead. That is, a combination of error-containing data at a target time and past inference data before the target time may be used as the input data.

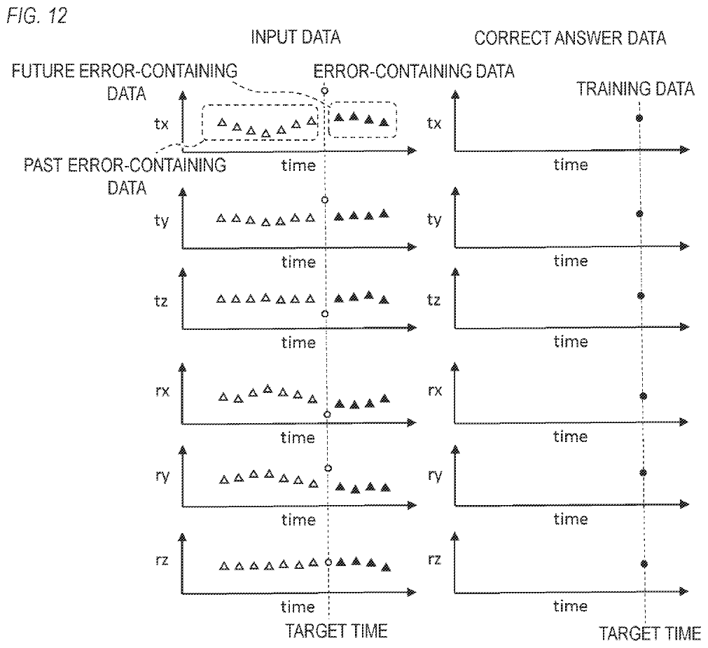

FIG. 12 illustrates an example of learning data for RMC. In the RMC method, subject motion correction is performed on accumulated measurement data in a post-processing manner. Accordingly, not only past data before the data subjected to the error reduction processing but also future data can be used for inference. Thus, for example, as illustrated in FIG. 12, input data including past error-containing data (white triangles), error-containing data (while circles) at a target time, and future error-containing data (black triangles), that is, time-series data obtained for a predetermined period of time including before and after the target time, may be used for learning. In this case, too, it is desirable that motion with a plurality of degrees of freedom be simultaneously learned. This makes it possible to perform inference in consideration of the linkage between a plurality of degrees of freedom. As a result, the tracking error can be reduced with high accuracy.

In the learning for RMC, too, as in the case of the PMC method, the learning may be performed for each combination of at least two degrees of freedom selected from the six degrees of freedom. Alternatively, as illustrated in FIGS. 10 and 11A, time-series data including past data and data at a target time may be used for learning. In addition, as illustrated in FIG. 11B, the learning may be performed using only data at the target time without using past data. Further, instead of past error-containing data, past inference data may be given as the past data. That is, a combination of past inference data, error-containing data at the target time, and future error-containing data may be used as the input data.

The learning is desirably performed by a parallel arithmetic processing apparatus including a large-scale parallel simultaneous reception circuit or a large-capacity memory, a high-performance graphics processing unit (GPU), and the like. By storing the trained model that has learned using the high-performance learning apparatus in the storage unit 203, the tracking error reduction processing can be performed even with a relatively simple apparatus without a large-scale and expensive hardware configuration.

### Inference

In the case of the PMC method that needs real-time processing, the inference unit 202 reduces an error from subject motion information calculated based on a newly captured camera image. The subject motion information based on the newly captured camera image may contain an error component. The inference unit 202 estimates, from the subject motion information based on the newly captured camera image, motion information in which the error component is reduced by using the trained model.

A format of the data input to the inference unit 202 is the same as that of the data used for learning of the trained model. For example, when learning is performed by using the data in FIG. 10, a data set including the current subject motion with six degrees of freedom calculated based on the newly captured camera image and subject motion with six degrees of freedom calculated based on the past camera image is input to the inference unit 202. The inference unit 202 estimates and outputs subject motion with six degrees of freedom in which the error is reduced, based on the subject motion with six degrees of freedom obtained for a predetermined period of time from the past to the present and the trained model. According to this method, since the time-series data is given as the input data, it is possible to perform inference in consideration of temporal linkage of the motion of the subject. For example, when sudden irregularity (outlier) appears in the measurement data due to a disturbance, the value thereof can be corrected to an appropriate value. In addition, by using the trained model with multi-degree-of-freedom input and output, it is possible to perform inference in consideration of linkage between a plurality of degrees of freedom. As a result, the tracking error can be reduced with high accuracy. This method is effective, for example, in a case where the motion of the subject is restricted as in MR imaging and a correlation or tendency is observed in the six degrees of freedom of motion of the subject.

In the case of a trained model that has been trained using data with two degrees of freedom as illustrated in FIG. 11A, data with two degrees of freedom is also used as an input to the inference unit 202. In a case where there is a plurality of trained models each having a different combination of degrees of freedom, the inference unit 202 may perform inference processing using each of the trained models. In this way, the motion of the subject with six degrees of freedom in which the error is reduced can be obtained.

In the case where past data is not used for learning as illustrated in FIG. 1I B, only the current motion of the subject calculated based on a newly captured camera image is used as an input to the inference unit 202. When past data is not used, inference in consideration of temporal linkage of the subject motion cannot be performed. However, it is possible to perform inference in consideration of linkage between a plurality of degrees of freedom. Therefore, certain accuracy can be expected in a situation such as MR imaging.

In the case of a trained model in which a combination of past inference data and error-containing data at a target time is used for learning, the inference unit 202 recursively uses a past estimated value obtained by the inference unit 202 itself as an input. That is, a data set including the current subject motion information calculated based on a newly captured camera image and the past subject motion information in which the error is reduced by the inference unit 202 is used as an input to the inference unit 202. When error-containing data is given as past data, there is a possibility that a tracking error contained in the past data adversely affects the inference processing at the target time. In contrast, when inference data (that is, data in which a tracking error is reduced) is used as past data, it can be expected that error reduction is perform on the data at the target time with high accuracy.

In the case of the RMC method, the inference unit 202 performs tracking error reduction processing on measurement data accumulated by MR imaging. For example, in the case where learning is performed using the data illustrated in FIG. 12, a set of time-series data obtained for a predetermined period of time including before and after the target time is input to the inference unit 202. The inference unit 202 reduces or eliminates an error component contained in the subject motion at the target time based on the input data set and the trained model.

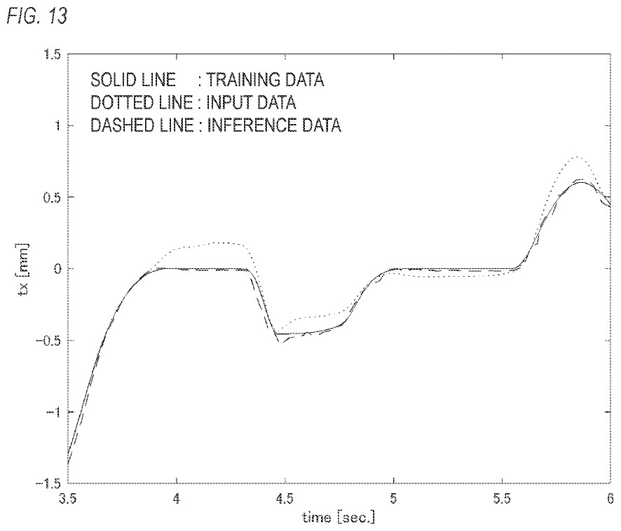

FIG. 13 illustrates an example of an application result of the tracking error reduction processing. In FIG. 13, a solid line indicates the motion of the head not containing a tracking error (correct answer data), a dotted line indicates the motion of the head containing a tracking error (input data), and a dashed line indicates an output result of the inference unit 202 (inference data). When the dashed line is compared with the dotted line, the dashed line is clearly closer to the solid line. This indicates that the error has been reduced.

By performing the error reduction processing according to the present invention, an error contained in a tracking measurement result is reduced so that the motion of the subject can be measured with high accuracy. Further, if a highly accurate measurement result for the motion of the subject is obtained, by using such an accurate measurement result for the control of a medical image diagnostic apparatus (for example, correction of a gradient magnetic field of an MRI apparatus) or image reconstruction, a high-resolution image with few artifacts can be obtained.

According to the present invention, the motion of the subject can be measured with high accuracy. Further, according to the present invention, an error caused by a disturbance can be reduced from the subject motion information obtained by tracking as much as possible.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-144489, filed on Sep. 6, 2021, which is hereby incorporated by reference herein in its entirety.

What is claimed is:

1. A subject motion measuring apparatus comprising:
at least one memory storing a program; and
at least one processor which, by executing the program, causes the subject motion measuring apparatus to:
measure motion of a subject and output motion information related to the motion of the subject;
reduce, from the motion information, an error caused by a disturbance other than the motion of the subject by using a trained model; and
output the motion information in which the error is reduced,
wherein the trained model has functions of receiving a data set including the motion information with a plurality of degrees of freedom and outputting the motion information with the plurality of degrees of freedom in which the error is reduced.

2. The subject motion measuring apparatus according to claim 1, wherein the motion information with the plurality of degrees of freedom is information about six degrees of freedom of motion including three degrees of freedom in translation and three degrees of freedom in rotation.

3. The subject motion measuring apparatus according to claim 1, wherein the trained model is trained by using a set of time-series data representing the motion information with the plurality of degrees of freedom, the time-series data being obtained for a predetermined period of time.

4. The subject motion measuring apparatus according to claim 3, wherein the time-series data obtained for the predetermined period of time includes data subjected to error reduction processing and past data before the data subjected to the error reduction processing.

5. The subject motion measuring apparatus according to claim 3, wherein the time-series data obtained for the predetermined period of time includes data subjected to error reduction processing, past data before the data subjected to the error reduction processing, and future data after the data subjected to the error reduction processing.

6. The subject motion measuring apparatus according to claim 4, wherein the at least one processor causes the subject motion measuring apparatus to use the motion information obtained by measuring the motion of the subject as the past data before the data subjected to the error reduction processing.

7. The subject motion measuring apparatus according to claim 4, wherein the at least one processor causes the subject motion measuring apparatus to use the motion information in which the error is reduced as the past data before the data subjected to the error reduction processing.

8. The subject motion measuring apparatus according to claim 1, wherein the trained model is trained by supervised learning using learning data that includes error-containing data, which is motion information containing an error, and training data, which is motion information not containing an error.

9. The subject motion measuring apparatus according to claim 8, wherein the error-containing data is data generated by adding error information generated by simulating a disturbance to motion information not containing an error.

10. The subject motion measuring apparatus according to claim 9, wherein
the at least one processor causes the subject motion measuring apparatus to calculate three-dimensional coordinates of feature points of the subject from an image captured by a camera imaging the subject and convert the three-dimensional coordinates of the feature points into motion information with a plurality of degrees of freedom about the subject, and
the error-containing data is data generated by adding the error information to the three-dimensional coordinates of the feature points in motion not containing an error and subsequently converting the three-dimensional coordinates of the feature points to which the error information is added into motion information with a plurality of degrees of freedom by using an algorithm identical to an algorithm used by calculating the three-dimensional coordinates of the feature points.

11. The subject motion measuring apparatus according to claim 1, wherein the at least one processor causes the subject motion measuring apparatus to measure motion of a human head as the motion of the subject.

12. The subject motion measuring apparatus according to claim 11, wherein the error caused by the disturbance includes an error caused by a vibration of the subject motion measuring apparatus or an error caused by a movement of skin of the subject.

13. A medical image diagnostic apparatus comprising:
at least one memory storing a program; and
at least one processor which, by executing the program, causes the medical image diagnosis apparatus to:
measure motion of a subject and output motion information related to the motion of the subject;
reduce, from the motion information, an error caused by a disturbance other than the motion of the subject by using a trained model;
output the motion information in which the error is reduced; and
perform processing using the output motion information in which the error is reduced,
wherein the trained model has functions of receiving a data set including the motion information with a plurality of degrees of freedom and outputting the motion information with the plurality of degrees of freedom in which the error is reduced.

14. The medical image diagnostic apparatus according to claim 13, wherein the medical image diagnostic apparatus is a magnetic resonance imaging apparatus.

15. A subject motion measuring method comprising:
measuring motion of a subject and outputting motion information related to the motion of the subject;
reducing, from the motion information, an error caused by a disturbance other than the motion of the subject by using a trained model obtained by machine learning; and
outputting the motion information in which the error is reduced,
wherein the trained model has functions of receiving a data set including the motion information with a plurality of degrees of freedom and outputting the motion information with the plurality of degrees of freedom in which the error is reduced.

16. A non-transitory computer readable medium that stores a program, wherein the program causes a computer to execute a subject motion measuring method including:
measuring motion of a subject and outputting motion information related to the motion of the subject;
reducing, from the motion information, an error caused by a disturbance other than the motion of the subject by using a trained model obtained by machine learning; and
outputting the motion information in which the error is reduced,
wherein the trained model has functions of receiving a data set including the motion information with a plurality of degrees of freedom and outputting the motion information with the plurality of degrees of freedom in which the error is reduced.
